(19) United States
(12) Patent Application Publication
(10) Pub. No.: US 2011/0251969 A1
(43) Pub. Date: Oct. 13, 2011

(54) SYSTEMS AND METHODS FOR VERIFYING AUTHENTICITY OF A PRODUCT

(75) Inventors: Ashifi Gogo, Hanover, NH (US); Alden Zecha, Somerville, MA (US)

(73) Assignee: SPROXIL, INC, Somerville, MA (US)

(21) Appl. No.: 13/081,909

(22) Filed: Apr. 7, 2011

Related U.S. Application Data
(60) Provisional application No. 61/321,530, filed on Apr. 7, 2010.
(60) Provisional application No. 61/321,525, filed on Apr. 7, 2010.

(51) Int. Cl. G06Q 99/00; B65D 83/04; B42D 15/00; G06Q 90/00

(52) U.S. Cl. 705/318; 705/500; 206/532; 283/53

(57) ABSTRACT

Various aspects of the invention provide systems and methods for verifying the authenticity of a product. One aspect of the invention provides a method of verifying the authenticity of a product through a plurality of stages of a supply chain. The method includes: providing a product having a plurality of distinct hidden unique identifiers incorporated with the product; and at each of at least one of the plurality of stages of the supply chain, verifying the authenticity of a revealed unique identifier, thereby verifying the authenticity of the product. Another aspect of the invention provides a product including a plurality of distinct hidden unique identifiers. The plurality of distinct unique identifiers can be selectively revealed. Another aspect of the invention provides a tamper-evident package including a plurality of distinct hidden unique identifiers. The plurality of distinct unique identifiers can be selectively revealed.

### CROSS-REFERENCE TO RELATED APPLICATIONS

This application claims priority to U.S. Provisional Patent Application Ser. Nos. 61/321,525 and 61/321,530, both filed on Apr. 7, 2010. The entire contents of each application are hereby incorporated by reference herein.

### BACKGROUND

Counterfeit goods remain a significant economic and consumer safety problem. Counterfeit pharmaceuticals pose particular safety problems because of the difficulty for even the most highly-educated consumers to determine whether a pharmaceutical product contains the correct quantity of an active ingredient or any active ingredient at all.

Various approaches have been used to combat counterfeit goods. For example, intricate packaging and labels have often been used under the theory that such labels are difficult for the would-be counterfeiter to mimic. However, advances in technology have lowered the prices for sophisticated printing equipment, thereby improving the quality of counterfeit packaging.

Accordingly, there is a need for new methods and devices for verifying authenticity of a product.

### SUMMARY OF THE INVENTION

Various aspects of the invention provide systems and methods for verifying the authenticity of a product.

One aspect of the invention provides a method of verifying the authenticity of a product through a plurality of stages of a supply chain. The method includes providing a product having a plurality of distinct hidden unique identifiers incorporated with the product and at each of at least one of the plurality of stages of the supply chain, verifying the authenticity of a revealed unique identifier, thereby verifying the authenticity of the product.

The step of verifying the authenticity of the revealed unique identifier can include comparing the revealed unique identifier with another unique identifier stored in a database. The step of verifying the authenticity of the revealed unique identifier can include, if the revealed unique identifier is marked in the database as valid, indicating that the revealed unique identifier is authentic. The step of verifying the authenticity of the revealed unique identifier can include, if the revealed unique identifier is marked in the database as invalid, indicating that the revealed unique identifier is not authentic. The step of verifying the authenticity of the revealed unique identifier can include, if the revealed unique identifier is marked in the database as used, indicating that the revealed unique identifier is not authentic. The step of verifying the authenticity of the revealed unique identifier can include, if the revealed unique identifier is marked in the database as stolen, indicating that the revealed unique identifier is not authentic. The step of verifying the authenticity of the revealed unique identifier can include, if the revealed unique identifier is marked in the database as compromised, indicating that the revealed unique identifier is not authentic.

Each of the plurality of distinct hidden unique identifiers can be incorporated in individual blisters within one or more blister packs. One or more of the plurality of distinct hidden unique identifiers can be obscured by a removable opaque coating.

One or more of the plurality of distinct hidden unique identifiers can be revealed by one or more selected from the group consisting of exposure to a temperature change, exposure to a substance, exposure to light, use of a lens of a defined wavelength, and exposure to energy of a defined wavelength.

The revealed unique identifier can be communicated via one or more communication means selected from the group consisting of visual inspection, voice, telephone, facsimile, e-mail, Internet communications, and Short Message Service.

One or more of the hidden unique identifiers can be selected from the group consisting of characters, letters, numerals, bar codes, matrix codes, human readable markings, and machine-readable markings. Each of the distinct hidden unique identifiers can be readable at a distinct wavelength.

The product can be received within tamper-evident packaging.

The method can include instructing a supply chain actor to reveal one of the plurality of distinct hidden unique identifiers. The supply chain actor can be a human. The supply chain actor can be a machine. The verifying step can be performed at each of the plurality of stages of the supply chain.

Another aspect of the invention provides a tamper-evident package including a plurality of distinct hidden unique identifiers. The plurality of distinct unique identifiers can be selectively revealed.

The plurality of distinct hidden unique identifiers can be incorporated within one or more blister packs. Each of the plurality of distinct hidden unique identifiers can be incorporated in individual blisters within the one or more blister packs. The plurality of distinct hidden unique identifiers can be incorporated within one or more scratch cards.

One or more of the hidden unique identifiers can be selected from the group consisting of characters, letters, numerals, bar codes, matrix codes, human readable markings, and machine-readable markings Each of the distinct hidden unique identifiers can be readable at a distinct wavelength.

Another aspect of the invention provides a method of verifying the authenticity of a product through a plurality of stages of a supply chain. The method includes: providing a product having a plurality of distinct hidden unique identifiers incorporated with the product; and at each of at least one of the plurality of stages of the supply chain, verifying the authenticity of a revealed unique identifier, thereby verifying the authenticity of the product.

This aspect of the invention can have a variety of embodiments. The step of verifying the authenticity of the revealed unique identifier can include: comparing the revealed unique identifier with another unique identifier stored in a database. The step of verifying the authenticity of the revealed unique identifier can include: if the revealed unique identifier is marked in the database as valid, indicating that the revealed unique identifier is authentic. The step of verifying the authenticity of the revealed unique identifier can further include: if the revealed unique identifier is marked in the database as invalid, indicating that the revealed unique identifier is not authentic. The step of verifying the authenticity of the revealed unique identifier can further include: if the revealed unique identifier is marked in the database as used, indicating that the revealed unique identifier is not authentic. The step of verifying the authenticity of the revealed unique identifier can further include: if the revealed unique identifier is marked in the database as stolen, indicating that the revealed unique identifier is not authentic. The step of verifying the authenticity of the revealed unique identifier can further include: if the revealed unique identifier is marked in the database as compromised, indicating that the revealed unique identifier is not authentic.

Each of the plurality of distinct hidden unique identifiers can be incorporated in individual blisters within one or more blister packs. One or more of the plurality of distinct hidden unique identifiers can be obscured by a removable opaque coating. One or more of the plurality of distinct hidden unique identifiers can be revealed by one or more selected from the group consisting of exposure to a temperature change, exposure to a substance, exposure to light, use of a lens of a defined wavelength, and exposure to energy of a defined wavelength.

The revealed unique identifier can be communicated via one or more communication means selected from the group consisting of visual inspection, voice, telephone, gestures, human-machine interactions, key presses, facsimile, e-mail, Internet communications, intranet communications, and Short Message Service (SMS), Unstructured Supplementary Service Data (USSD), Process Supplementary Service Request (PSSR), Unstructured Supplementary Service Request (USSR), Unstructured Supplementary Service Notify (USSN), and SIM Application Toolkit (STK).

One or more of the hidden unique identifiers can be selected from the group consisting of characters, letters, numerals, bar codes, matrix codes, human readable markings, and machine-readable markings.

Each of the distinct hidden unique identifiers can be readable at a distinct wavelength.

The product can be received within tamper-evident packaging.

The method can further include: instructing a supply chain actor to reveal one of the plurality of distinct hidden unique identifiers. The supply chain actor can be a human. The supply chain actor can be a machine.

The verifying step can be performed at each of the plurality of stages of the supply chain. One or more of the plurality of distinct hidden unique identifiers can be modified by one or more selected from the group consisting of exposure to an environmental condition, exposure to a substance, and use of a lens of a defined wavelength. The environmental condition can be selected from the group consisting of a temperature, light, and energy of a defined condition. One or more of the plurality of distinct hidden unique identifiers can be modified by exposure to the environmental condition for a defined period of time. The substance can be water.

The method can further include: recording a time at which the revealed unique identifier is received; and calculating a difference between a previously recorded time and the time at which the revealed unique identifier was received.

The product can be a ticket. The product can be a voucher.

The method can further include: removing the revealed unique identifier from the product.

Another aspect of the invention provides a product including a plurality of distinct hidden unique identifiers. The plurality of distinct unique identifiers can be selectively revealed.

Another aspect of the invention provides a tamper-evident package including a plurality of distinct hidden unique identifiers. The plurality of distinct unique identifiers can be selectively revealed.

This aspect of the invention can have a variety of embodiments. The plurality of distinct hidden unique identifiers can be incorporated within one or more blister packs. Each of the plurality of distinct hidden unique identifiers can be incorporated in individual blisters within the one or more blister packs.

The plurality of distinct hidden unique identifiers can be incorporated within one or more scratch cards.

One or more of the hidden unique identifiers can be selected from the group consisting of characters, letters, numerals, bar codes, matrix codes, human readable markings, and machine-readable markings.

Each of the distinct hidden unique identifiers can be readable at a distinct wavelength.

One or more of the plurality of distinct hidden unique identifiers can be modified by one or more selected from the group consisting of: exposure to an environmental condition, exposure to a substance, and use of a lens of a defined wavelength. The environmental condition can be selected from the group consisting of: a temperature, light, energy, stress, strain, and magnetic forces. One or more of the plurality of distinct hidden unique identifiers can be modified by exposure to the environmental condition for a defined period of time. The substance can be water.

Another aspect of the invention provides a ticket including a plurality of unique identifiers.

This aspect of the invention can have a variety of embodiments. The ticket can permit admission to an event selected from the group consisting of: an entertainment event, an exhibition, an art exhibition, a tour, a museum, an amusement park, a theme park, a sporting event, a concert, a play, and a movie. The plurality of unique identifiers can be hidden. Each of the plurality of unique identifiers can be printed on a separate perforated portion of the ticket.

### FIGURES

For a fuller understanding of the nature and desired objects of the present invention, reference is made to the following detailed description taken in conjunction with the figure wherein:

FIGS. 1 and 2 depict cross-sections of tamper-evident packages containing a unique identifier according to the invention;

FIG. 3 depicts a blister pack having a unique identifier printed on the lidding material according to the invention;

FIG. 4 depicts a tamper-evident package containing a unique identifier that can be coupled to an item according to the invention;

FIGS. 5 and 6A-6C depict environmentally-sensitive unique identifiers according the invention;

FIGS. 7 and 8 depict methods of providing a unique identifier according to the invention;

FIG. 9 depicts a tamper-evident package according to the invention;

FIG. 10 depicts a method of verifying the authenticity of a product through a plurality of stages of a supply chain according to the invention;

FIG. 11 depicts an exemplary workflow according to the invention;

FIG. 12 depicts a ticket including a plurality of unique identifiers according to the invention; and

FIG. 13 depicts a method of verifying the authenticity of a ticket or other voucher according to the invention.

### DEFINITIONS

The instant invention is most clearly understood with reference to the following definitions:

As used in the specification and claims, the singular form “a,” “an,” and “the” include plural references unless the context clearly dictates otherwise.

The term “visible” refers to any feature that is perceptible at a defined wavelength. Such a wavelength can be the portion of the electromagnetic spectrum perceptible to the human eye (i.e., between about 390 nm to about 750 nm). Such a wavelength can additionally or alternatively include other wavelengths visible through the use of machines and/or lenses.

The term “opaque” refers to any material that does not permit the perception of a feature from across the material at a defined wavelength. Such a wavelength can be the portion of the electromagnetic spectrum perceptible to the human eye (i.e., between about 390 nm to about 750 nm). Such a wavelength can additionally or alternatively include other wavelengths visible through the use of machines and/or lenses.

The term “environmental condition” refers to any ambient condition that can affect a product and/or the visibility of a unique identifier. Examples of environmental conditions include light, temperature, pressure, energy, and like. As used herein, environmental conditions may, but need not be, modified by a temporal duration. For example and as discussed further herein, exposure to a slightly elevated temperature for a short period of time may not be sufficient to compromise a product or cause a unique identifier to be revealed and/or modified. However, exposure to the same slightly elevated temperature for a 6 hours may be sufficient to compromise the product cause the unique identifier to be revealed and/or modified.

### DETAILED DESCRIPTION

Various aspects of the invention provide systems and methods for verifying the authenticity of a product, for example, products that are perishable, likely to be counterfeited, and/or likely to be mishandled.

Exemplary products include pharmaceutical products such as vaccines, pills, capsules, tablets, orally disintegrating tablets, films, osmotic-controlled release oral delivery systems (OROS), elixirs, emulsions, syrups, suspensions, tinctures, inhalers, nebulizers, eye drops, ear drops, ointments, creams, lotion, liniments, gels, pastes, medicated shampoos, transdermal implants, transdermal patches, intranasal pharmaceuticals, subcutaneous (SC) pharmaceuticals, intravenous (IV) pharmaceuticals, intramuscular (DA) pharmaceuticals, intraosseuous pharmaceuticals, intraperitoneal (IP) pharmaceuticals, intrathecal pharmaceuticals, intracavernosal pharmaceuticals, pessaries, vaginal rings, intrauterine devices, suppositories, and the like.

Other exemplary products include consumer goods (e.g., clothing, luggage, and the like), electronic goods, foodstuffs, alcoholic beverages (e.g., beer, wine, spirits, and the like), electronic media (e.g., compact discs, digital video discs, and the like), luxury goods (e.g., jewelry, watches, perfumes, and the like), cosmetics, software, and the like.

### Systems Containing Unique Identifiers

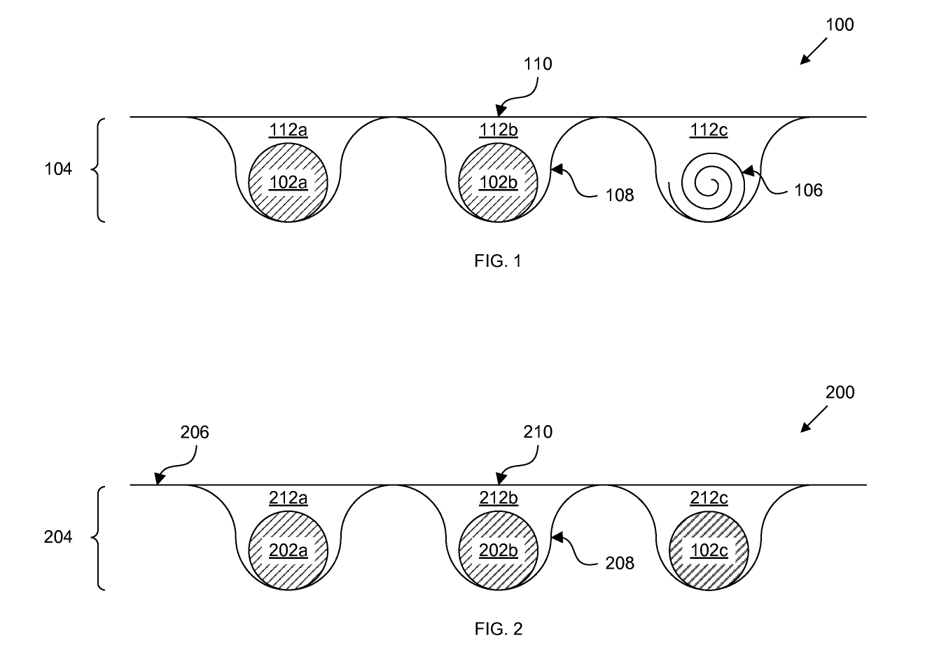

Referring now to FIG. 1, some embodiments of the invention provide a system 100 for verifying the authenticity of a product 102 containing therein. The system includes a tamper-evident package 104 and a unique identifier 106 contained within or as part of the tamper-evident package 104.

Tamper-evident package 104 can be any package configured such that an end user can easily identify if the product 102 and/or the unique identifier 106 were previously removed or altered. For example, tamper-evident package 104 can be any package that requires a visible alteration to access the unique identifier. In specific examples, the user can be required to: open a bottle to view a unique identifier under a cap; open a box or sachet to view a unique identifier within the box or sachet; open an envelope to view a unique identifier within the sachet; squeeze a unique identifier out of a tube of product; open a packet (e.g., of hard-molded plastic) to access a unique identifier; pour a unique identifier out of a package (e.g., TETRA PAK® packages).

As depicted in FIG. 1, the tamper-evident package 104 can be a blister pack (also known as a “push-through-pack”) consisting of a blister material 108 and a lidding material 110 defining one or more cavities 112. Blister packs and methods of fabricating the same are described in D. A. Dean, Blister, Strip & Sachet Packaging in Pharmaceutical Packaging Technology (D. A. Dean et al., eds. 2000).

The blister pack can be formed from a variety of existing materials known to those of skill in the art. For example, the blister material 108 can be fabricated from plastics such as polyvinyl chloride (PVC), polychlorotrifluoro ethylene (PCTFE), cyclic olefin polymers (COP), cyclic olefin copolymers (COC), polypropylene (PE), polyethylene (PE), glycol-modified polyethylene terephthalate (PETg), and the like, as well as combinations and/or laminates thereof. Lidding material 110 can be fabricated from a foil, for example, a metallic foil such as aluminum foil. The lidding material 110 can be bonded to the blister material 108 with one or more adhesives known by those of skill in the art to be suitable for bonding a particular blister material 108 and a particular lidding material 110. Suitable materials are further described in Edward J. Bauer, Pharmaceutical Packaging Handbook 189-272 (2009).

Unique identifier 106 can be any sequence of one or more characters that uniquely identifies a product. For example, unique identifier 106 can be a sequence of numerals (e.g., “1234567890”), a sequence of letters (e.g., “ABCDEFGHIJ”), a sequence of non-alphanumeric characters, and the like or a combination of the above. Although the examples herein utilize Arabic numerals and Latin characters, unique identifiers can be composed of other numerals and characters. Unique identifier 106 can also be a bar code or a matrix code (i.e., a two-dimensional bar code). A distinct unique identifier can be assigned to each individual product or a single unique identifier can be assigned to multiple products.

Unique identifiers 106 can be automatically generated with computers, printers, labeling machinery, and the like. For example, unique identifiers 106 can be generated with a random number generator. Unique identifiers 106 can be stored by the manufacturer and associated with a variety of data such as the time and date of manufacture, the location of manufacture, the distributor of the product, the status of the unique identifier 106, and the like.

The unique identifier 106 can be printed on a substrate (e.g., a piece of paper, card stock, cardboard, plastic, and the like) as depicted in FIG. 1. Preferably, the unique identifier 106 cannot be viewed be without opening the tamper-evident package 104. In order to obscure the unique identifier, the substrate can be rolled as depicted in FIG. 1, folded (e.g., like an accordion), and the like. The tamper-evident package 104 can be wholly or partially composed of an opaque material.

The unique identifier can be printed on the blister material 108 and/or the lidding material 110.

Additional media can be placed in other blister cavities. Such media can contain additional unique identifiers and/or marketing materials.

Cavities 112 containing the unique identifier or other additional media can have the same, similar, or different colors, shapes, and/or dimensions as other cavities (e.g., cavities containing pharmaceuticals). For example, cavities 112 can be substantially round, oval, rectangular, or the like.

Referring now the FIG. 2, the invention also provides a system 200 including a tamper-evident package 204 including a concealed unique identifier 206 coupled to the tamper-evident package 204. The concealed unique identifier 206 can be coupled to the tamper-evident package 204 by a variety of techniques. The concealed unique identifier 206 can be printed, stamped, or written on the tamper-evident package 204. The concealed unique identifier 206 can be printed on another media (e.g., paper, cardboard, and the like) and bonded to tamper-evident package 204 with a chemical or mechanical fastener (e.g., during repackaging).

The concealed unique identifier 206 can be configured to conceal a unique identifier until the end user wishes to verify the authenticity of the product 202. For example, the concealed unique identifier 206 can be a scratchcard-type material in which the unique identifier is covered by a removable opaque coating (e.g., latex). In another example, the concealed unique identifier 206 can be concealed by a substrate such as a sheet of paper, cardstock, cardboard, plastic, or the like. For example, the concealed unique identifier 206 can be covered by a perforated substrate that is torn during authentication. In still another example, the concealed unique identifier is concealed by one or more layers of removable tape (e.g., two-layer tape).

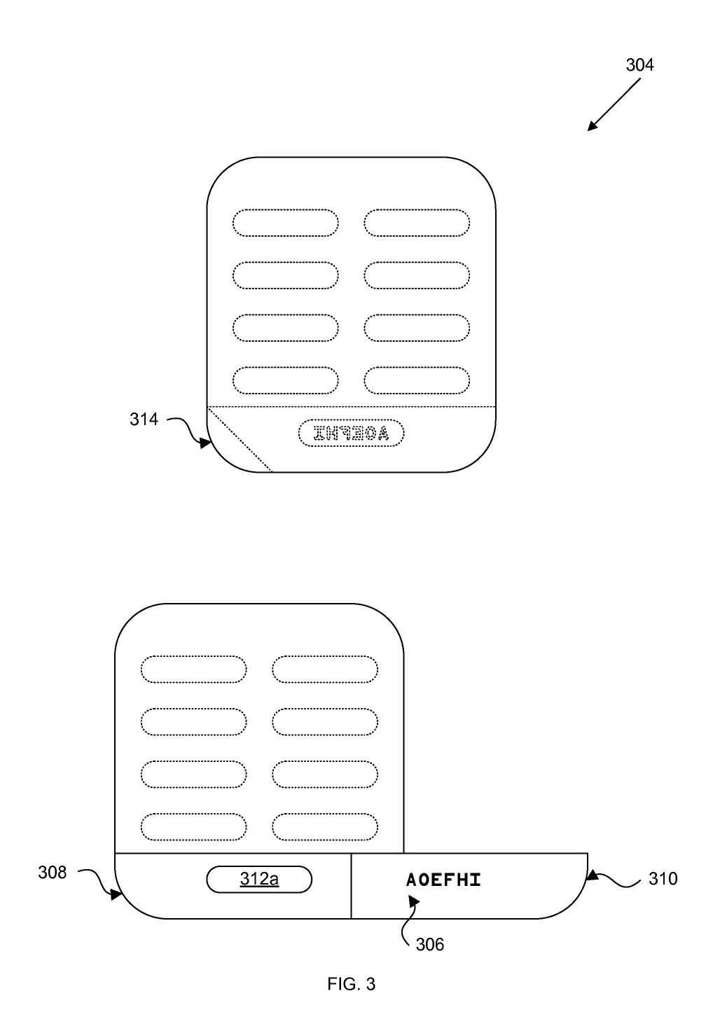

Referring now to FIG. 3, the unique identifier 306 can be printed on the inside of the tamper-evident package 304, for example on the inside of the blister material 308 or lidding material 310 in a blister pack. Lidding material 310 can be peeled by the end user (e.g., through the use of a tab 314 to reveal the unique identifier 306. Cavity material 308 is preferably opaque so that the unique identifier 306 cannot be viewed until the lidding material 310 is removed. Such arrangements can be particularly advantageous because they require little modification to existing packaging machinery and therefore can be produced at low cost. Moreover, such embodiments do not require any modification of existing blister packs. Indeed, blister 312a can contain a pill or other product.

### Blister Attachments

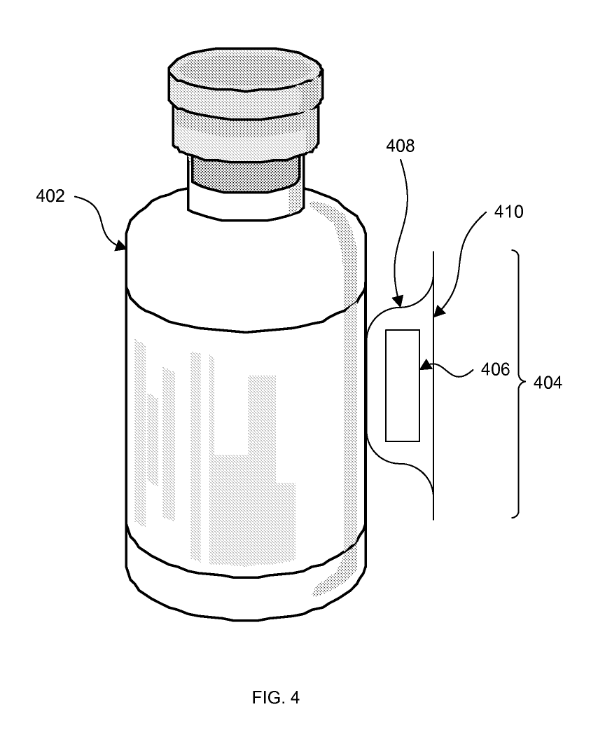

Referring now to FIG. 4, a tamper-evident package 402 containing a unique identifier 404 can be coupled to item 406 to allow for the authentication of the item 406. The tamper-evident package 402 can be a blister pack as discussed herein. The tamper-evident package 402 can be coupled to the item through a variety of means including mechanical and chemical fasteners. As discussed herein, unique identifier 404 can be printed in media received within the tamper-evident package 402 or can be printed directly on the blister material 408 and/or lidding material 410.

Tamper-evident package 402 can optionally be removed by item 406 after verification by the end user or other individual. For example, tamper-evident package 402 and item 406 can be detachably coupled through use of a temporary adhesive such as those available from Glue Dots International of New Berlin, Wis.

### One-Time-Use Unique Identifiers

It is preferable that the end user is able to quickly identify if the unique identifier 106, 206 was previously revealed for viewing. Such configurations are advantageous because a previously-revealed unique identifier 106, 206 suggests that the packaging 104, 204 was recycled and filled with a counterfeit product. A variety of approaches can be adopted to produce one-time-use unique identifiers.

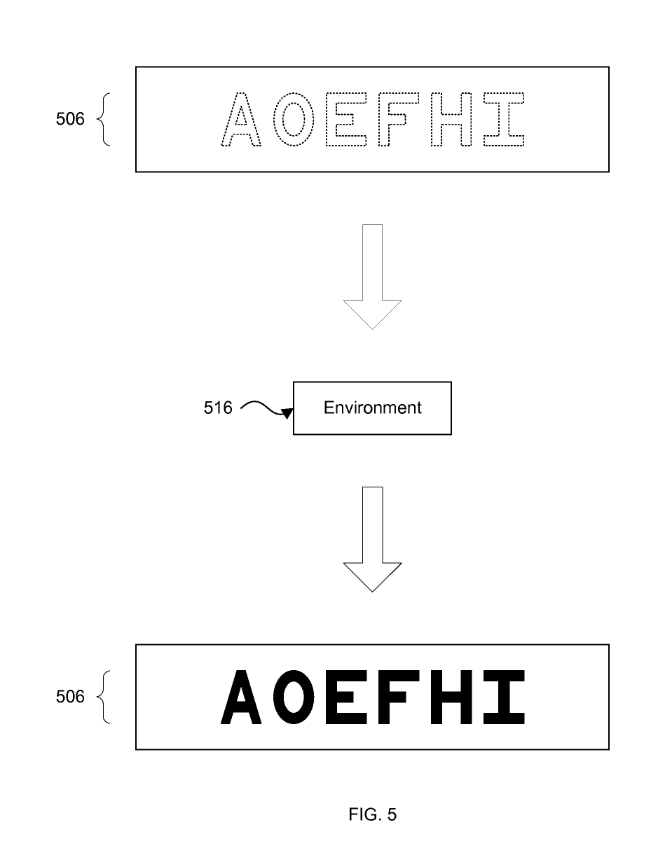

Referring now to FIG. 5, the unique identifier 506 can be revealed by a change in environmental conditions 516 such exposure to a temperature change, exposure to air, exposure to water, exposure to solvents, exposure to light, and exposure to radiation. Preferably, the revelation of the unique identifier 506 is irreversible so that the end user is alerted that the unique identifier 506 was previously viewed, which suggests that a counterfeiter recycled old packaging. In other configurations, the unique identifier is transitory such that the unique identifier can only be temporarily viewed.

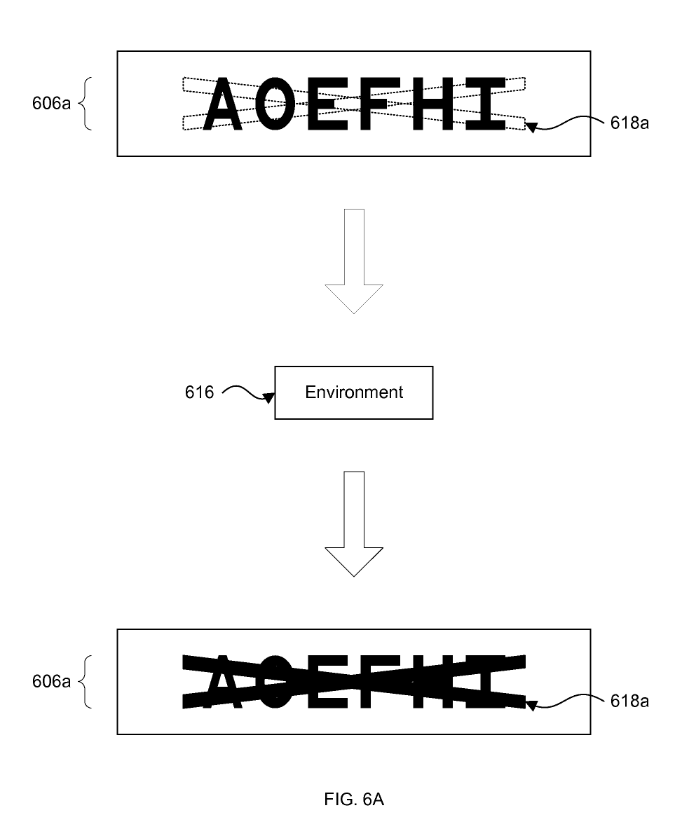

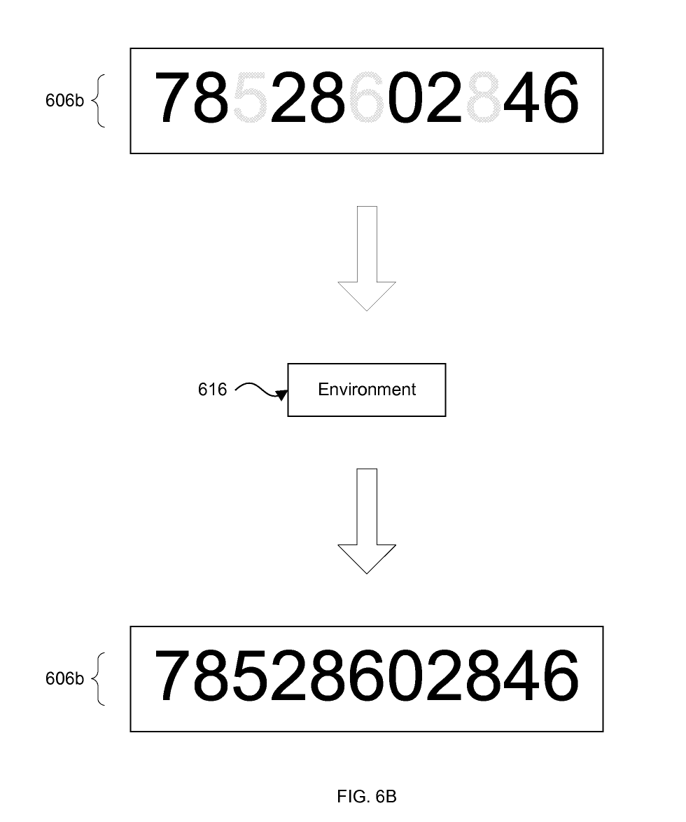

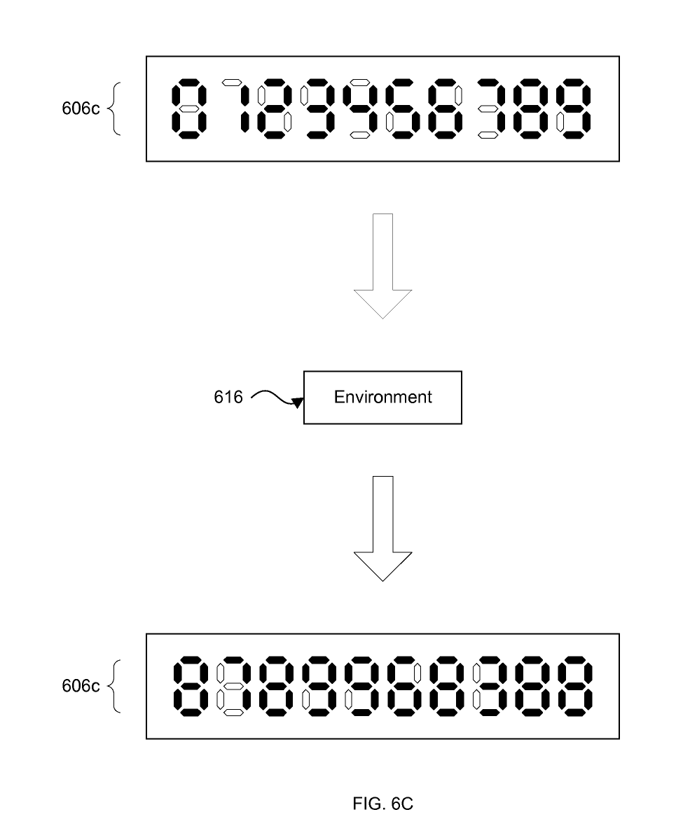

As depicted in FIG. 6A, the unique identifier 606a can be obscured by a mark 618a that becomes visible in response to an environmental condition 616 as discussed above. The obscuring mark 618a can be revealed by exposure to radiation incident to exposure of the unique identifier 606a during authentication. Additionally or alternatively, the obscuring mark 618a can be revealed by exposure to unacceptable environmental conditions. For example, the obscuring mark 618a can be revealed if the obscuring mark (and the product associated therewith) is exposed to heat, cold, humidity, and the like. Such arrangements are particularly advantageous for pharmaceuticals such as vaccines that are particularly sensitive to environmental conditions such as heat.

The obscuring mark 618a can be the same or a different color than the unique identifier 606a and can partially or completely obscure the unique identifier 606a.

Referring now to FIG. 6B, another embodiment of the invention provides a one-time-use unique identifier 608b that does not require the consumer's judgment in order to assess whether the unique identifier 608b was previously viewed and/or is otherwise compromised. Unique identifier 608b consists of a number of characters (e.g., 11 digits). One or more of the characters (the third, sixth, and ninth digits in the example illustrated in FIG. 6B) are printed in an environmentally-sensitive ink (e.g., a temperature sensitive ink) represented by light shading in FIG. 6B. If the user reads the unique identifier 608b before the unique identifier 608b (and the product associated therewith) is exposed to an environmental condition (e.g., high or low temperatures) the characters printed in the environmentally-sensitive ink will not be visible. For example, the user of the unique identifier 608b in FIG. 6B would see the code “78 28 02 46” and submit this code for verification as discussed herein. However, if the unique identifier 608b (and the product associated therewith) is exposed to an environmental condition (e.g., high or low temperatures), the characters printed in the environmentally-sensitive ink will become visible. For example, the user of the unique identifier 608b in FIG. 6B would see the code “78528602846” and submit this code for verification as discussed herein, thereby triggering a different response.

Referring now to FIG. 6C, another embodiment of the invention provides a unique identifier 608c encoded in a seven-segment display. Various segments of each digit can be printed in environmentally sensitive ink (depicted in dashed outline) such that when the unique identifier 608c is exposed to an environmental stimulus, the visible unique identifier 608c changes from “0123456789” to “8789968388.” For example, 0 can change to 8, 1 can change to 7, 2 can change to 8, 3 can change to 9, 4 can change to 9, 5 can change to 6, 6 can change to 8, 7 can change to 3, 8 can be maintained as 8, and 9 can change to 8.

Various combinations of environmentally-sensitive inks can be utilized to obtain more detailed information regarding the environmental exposure of the unique identifiers 608a or 608b (and the product associated therewith). For example, each of the hidden digits or segments can be printed in a different ink that becomes visible at various temperatures. Thus, by analyzing which characters are visible, one can determine not only whether the unique identifier 608a was exposed to heat or cold, but also identify one or more temperature ranges. Likewise, certain digits or segments can be printed in light-sensitive ink while other digits or segments can be printed in temperature-sensitive link.

The environmentally-sensitive inks discussed herein can be calibrated to become visible in response to exposure to an environmental condition (e.g., temperature and/or light) for a specified duration (e.g., 5 minutes, 15 minutes, 30 minutes, 1 hour, 3 hours, 6 hours, 12 hours, 1 day, and the like). The appearance of the environmentally-sensitive inks can vary as a function of both time and temperature. For example, exposure of an environmentally-sensitive ink to an ambient temperature of 50° C. for 60 minutes can produce the same effect as exposure of the environmentally-sensitive ink to an ambient temperature of 75° C. for 30 minutes.

Additionally or alternatively, environmentally-sensitive inks that disappear (as opposed to appear) when exposed to environmental conditions can be utilized to produce changing unique identifiers. In such an embodiment, the environmentally-sensitive ink would disappear upon exposure to an environmental condition, thereby producing a unique identifier. For example, inks that disappear upon exposure to temperatures are available from Chromatic Technologies of Colorado Springs, Colo.

In still another embodiment, environmentally-sensitive inks can be activated by forces such as stress, strain, and/or magnetism. For example, the segments of the unique identifiers can include liquid crystals that experience a change in optical properties upon exposure to stress, strain, and/or magnetism.

Notably, the user utilizes the same authentication process regardless of whether the unique identifiers 608b, 608c was exposed to an environmental condition. Thus, the user does not need to interpret the unique identifiers 608b, 608c. Rather, the authentication service can provide further instructions if the unique identifier 608b, 608c was compromised.

### Multiple Unique Identifiers

Multiple unique identifiers can be used in conjunction with the inventions herein. The multiple identifiers can appear in the same or separate location within the tamper-evident package. The multiple unique identifiers can be related or unrelated to each other. For example, package can have one visible unique identifier and one hidden unique identifier.

### Methods of Providing a Unique Identifier

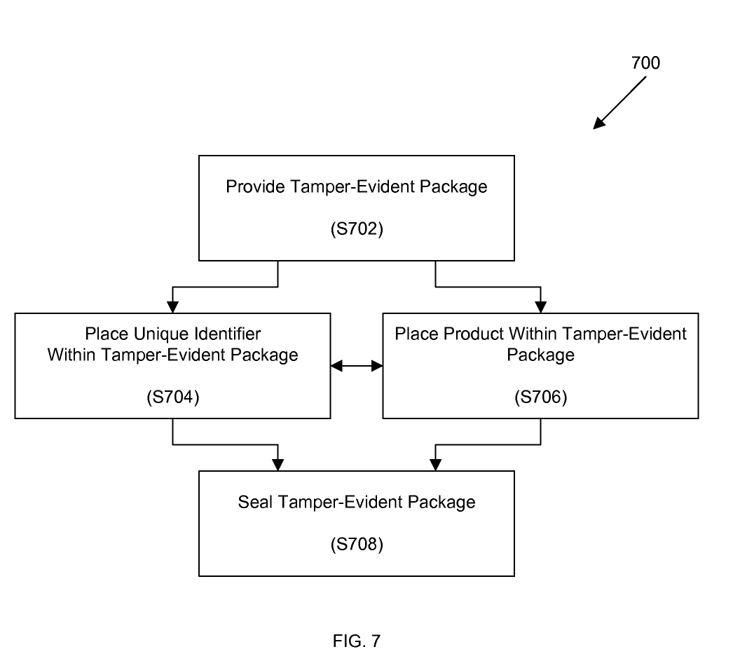

Referring now to FIG. 7, a method 700 of providing a unique identifier is provided.

In step S702, a package is provided. The package can be a tamper-evident package as provided herein.

In step S704, the unique identifier is placed within the package. The unique identifier can be placed within the package by hand or with conventional or specialized automated machinery.

In step S706, one or more products are optionally placed within the package. The one or more products can be placed within the package by hand or with conventional or specialized machinery.

In step S708, the package is optionally sealed. The package can be sealed by hand or with conventional or specialized machinery. The sealing of the package can render the package tamper-evident.

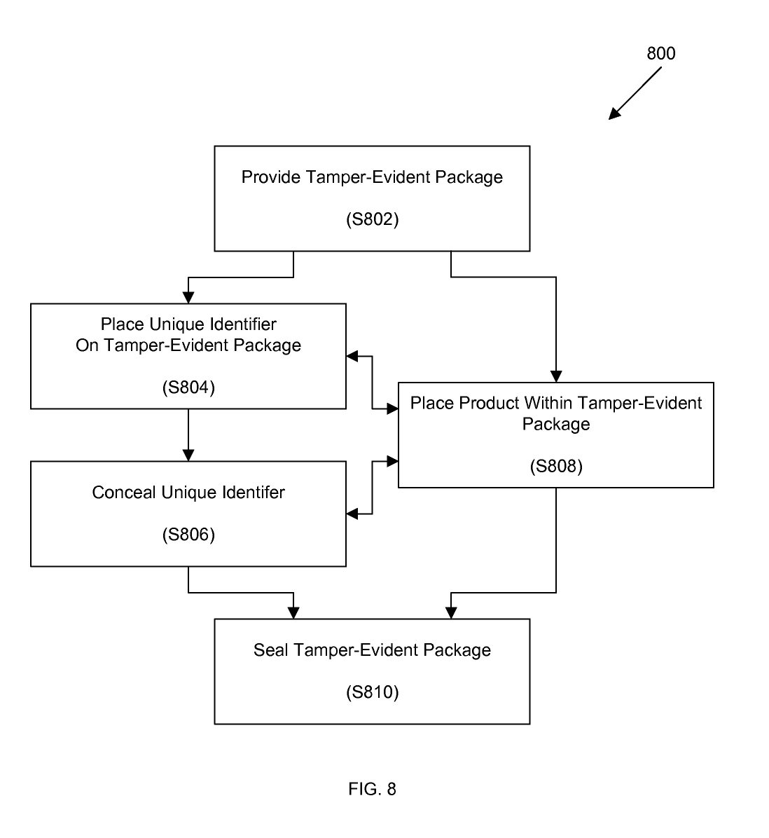

Referring now to FIG. 8, another method 800 of providing a unique identifier is provided.

In step S802, a package is provided. The package can be a tamper-evident package as provided herein.

In step S804, the unique identifier is placed on the package. The unique identifier can be placed on the package by hand or with conventional or specialized automated machinery.

In step S806, the unique identifier is concealed. The unique identifier can be concealed by hand or with conventional or specialized automated machinery. For example, a removable opaque coating can be applied over the unique identifier. In another example, a substrate such as piece of paper, cardstock, cardboard, plastic, or the like is placed over the unique identifier as discussed herein.

In step S808, one or more products are optionally placed within the package. The one or more products can be placed within the package by hand or with conventional or specialized machinery.

In step S810, the package is optionally sealed. The package can be sealed by hand or with conventional or specialized machinery,

### Tracking of Products Through a Supply Chain

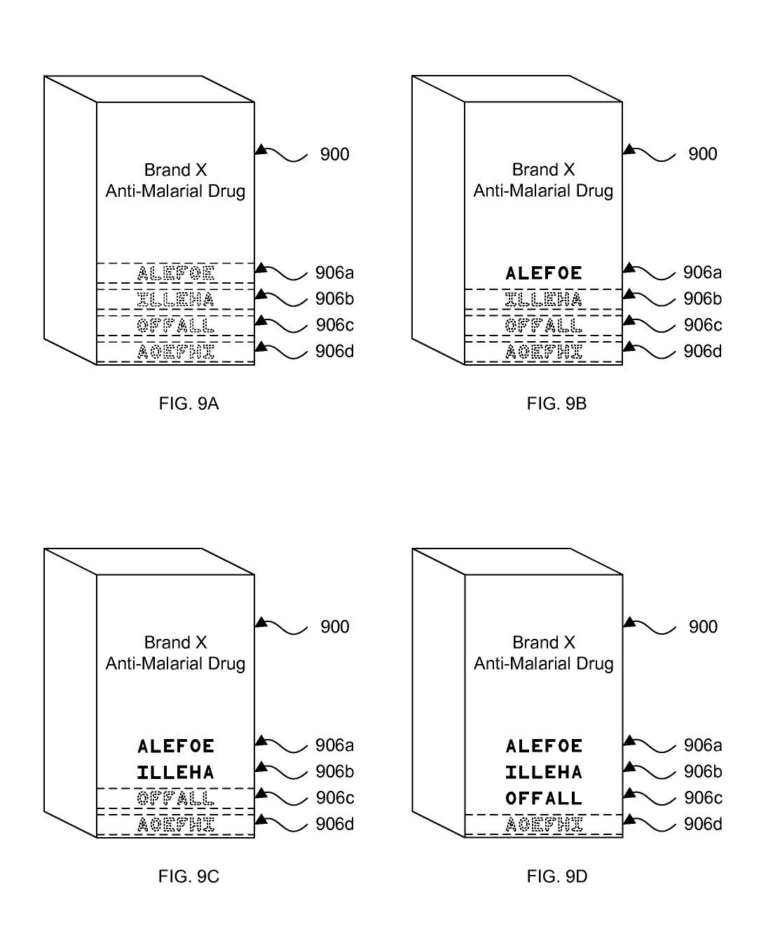

Referring now to FIGS. 9A-9D, the invention provides a tamper-evident package 900 including a plurality of distinct hidden unique identifiers 906 that can be selectively revealed.

The hidden unique identifier 906 can be hidden unique identifiers 906 according to any of the teachings herein. For example, the hidden unique identifiers 906 can be covered by a removable opaque coating or a perforated substrate.

In FIG. 9A, none of the unique identifiers 906 are revealed. This can be the first state of the package 900, for example, at the time that the package 900 leaves a factory.

In FIG. 9B, the package 900 is transferred to another level of the supply chain. For example, the package 900 can be sold from the manufacture to a wholesaler. Anyone wishing to verify the authenticity of the product contained in package 900 can reveal a first unique identifier 906a and verify the unique identifier 906a as discussed herein.

In FIG. 9C, the package 900 is transferred to another level of the supply chain. For example, the package 900 can be sold by the wholesaler to a retailer. Anyone wishing to verify the authenticity of the product contained in package 900 can reveal a second unique identifier 906b and verify the unique identifier 906b as discussed herein.

In FIG. 9D, the package 900 is transferred to another level of the supply chain. For example, the package 900 can be sold by the retailer to a consumer. Anyone wishing to verify the authenticity of the product contained in package 900 can reveal a third unique identifier 906c and verify the unique identifier 906c as discussed herein.

The package 900 can be configured to include a distinct hidden unique identifier 906 corresponding to each stage of a supply chain. For example, package 900 can include a sufficient number of distinct hidden unique identifiers 906 such that a unique identifier 906 can be verified every time the package 900 is transferred from one supply chain actor to another supply chain actor. The package 900 can also be configured to include sufficient unique identifiers 906 to allow for verification at other time points (e.g., when clearing customs). In still another example, the unique identifier 906 is not verified at every stage of the supply chain, but is rather verified at a subset of stages.

The distinct hidden unique identifiers 906 can be hidden in the same manner or in different manners. The distinct hidden unique identifiers can be detected with the human eye or can be detected utilizing optical or mechanical systems. For example, a bar code reader can be utilized to read unique identifiers 906 that are bar codes or matrix codes.

In another example, the distinct hidden unique identifiers 906 are readable at distinct wavelengths. In such an example, a plurality of lenses can be used to read the distinct hidden unique identifiers 906. The distinct hidden unique identifier 906 can be related such that validation of one or more previous hidden unique identifiers 906 is required in order to validate a subsequent unique identifier 906. For example, the wavelength of a subsequent unique identifier 906 can be revealed upon validation of a previous unique identifier 906.

In still another example, the distinct hidden unique identifiers 906 can be revealed by exposure to a plurality of wavelengths (e.g., the range of wavelengths present in sunlight or produced by fluorescent or incandescent lighting).

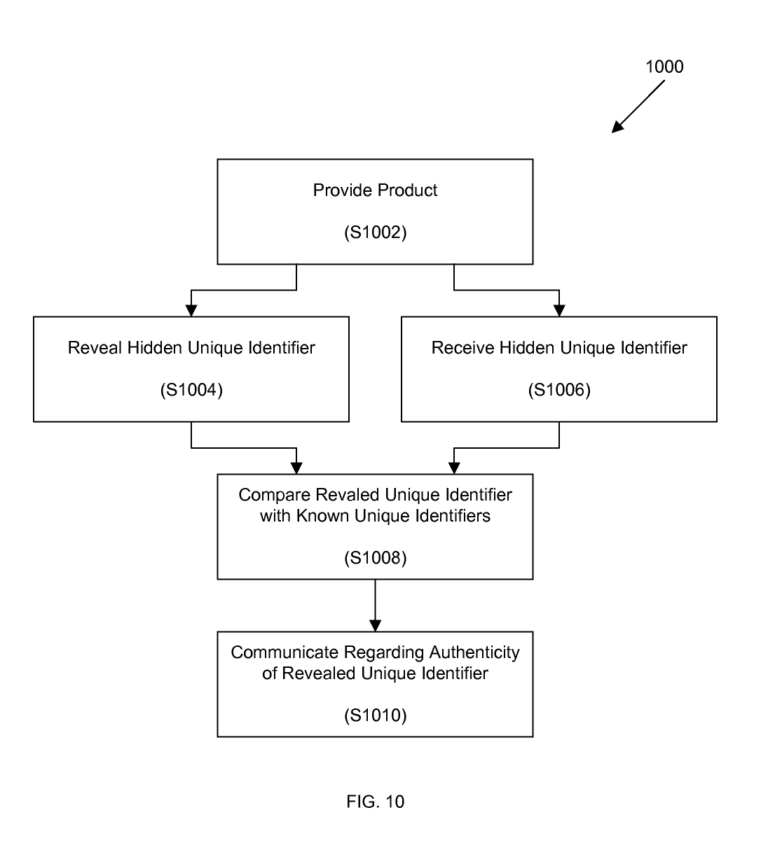

Referring now to FIG. 10, a method 1000 of verifying the authenticity of a product through a plurality of stages of a supply chain is provided.

In step S1002, a product having a plurality of distinct hidden unique identifiers is provided as described herein. The product can be received within tamper-evident packaging as discussed herein.

In step S1004, the hidden unique identifier is optionally revealed. The hidden unique identifier 906 can be revealed as part of the method or another entity can reveal the hidden unique identifier 906, with our without the instructions of the entity practicing the method. The hidden unique identifier 906 can be revealed by a human or a machine. For example, various devices for opening blister packs are described in U.S. Pat. Nos. 5,431,283; 5,853,101; 7,051,898; and 7,284,661; as well as U.S. Patent Application Publication Nos. 2008/0083309 and 2009/0199346.

In step S1006, the revealed unique identifier is optionally received from a supply chain actor. The revealed unique identifier can be received via a communication means such as voice, telephone, gestures, human-machine interactions, key presses, facsimile, e-mail, Internet communications, Short Message Service (SMS), Unstructured Supplementary Service Data (USSD), Process Supplementary Service Request (PSSR), Unstructured Supplementary Service Request (USSR), Unstructured Supplementary Service Notify (USSN), SIM Application Toolkit (STK), and the like, as well as other common telephony and Internet standards.

In step S1008, the revealed unique identifier is compared to one or more known unique identifiers. The one or more known unique identifiers can be stored in a secure location such as a database, computer-readable medium, and the like. The known unique identifiers can be associated with a status such as “valid,” “invalid,” “used,” “stolen,” “compromised,” “diverted,” and the like.

In step S1010, a communication regarding the revealed unique identifier is transmitted, for example, to the supply chain actor that submitted the verification request. The communication can be as simple as “authentic” or “not authentic” or can be more complex and can include further information on why the product is not authentic, instructions on how to report an unauthentic product, instructions for obtaining an authentic product, and the like. An unauthentic unique identifier can also be referred to one or more appropriate individuals or entities for investigation.

### Exemplary Workflow

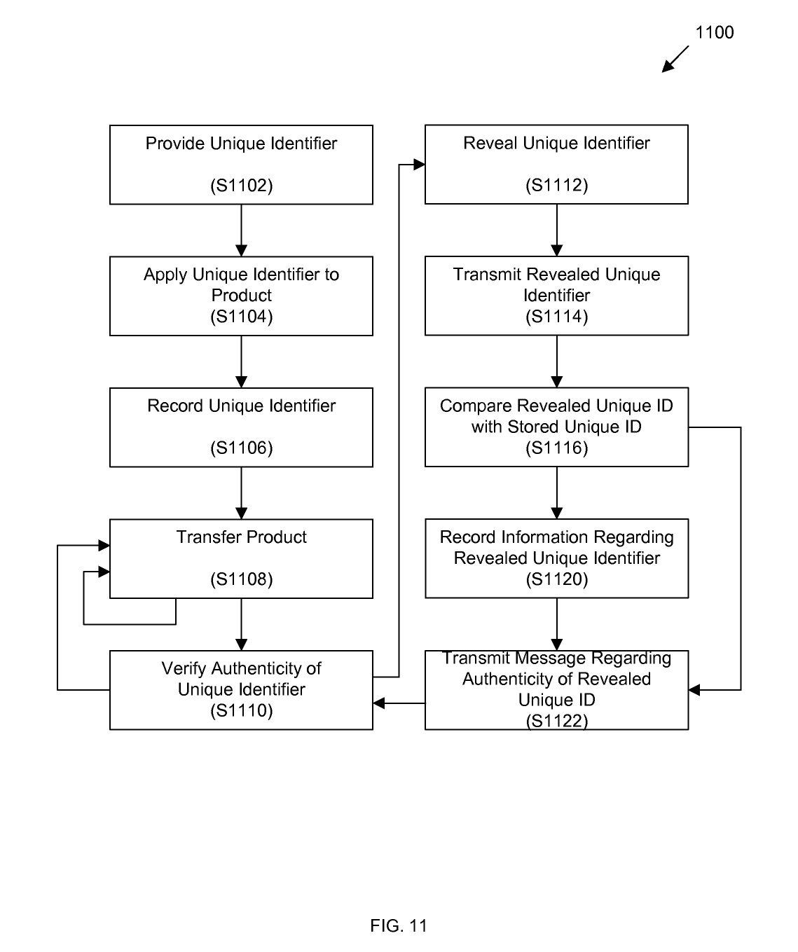

Referring now to FIG. 11, the inventions described herein are further explained in the context of the following exemplary workflow 1100.

In step S1102, one or more unique identifiers are provided. The one or more unique identifiers can be provided from list of unique identifiers (e.g., stored on a database) or can be generated in real time (e.g., using a random number generator or other algorithm).

In step S1104, the one or more unique identifiers are applied to a product. The unique identifiers can be applied according to the techniques described herein. For example, the unique identifiers can be placed within or applied to tamper-evident packaging and can optionally be concealed.

In step S1106, the unique identifiers can be recorded (e.g., if not previously recorded). For example, the unique identifiers can be associated with data about the manufacture of the product (e.g., date of manufacture, batch information, and the like). The unique identifiers can also be associated with the other unique identifiers applied to the product.

In step S1108, the product is transferred to one or more supply chain actors.

In step S1110, the subsequent supply chain actor can optionally verify the authenticity of the unique identifier and thereby verify the authenticity of the product.

In step S1112, a unique identifier can be revealed as discussed herein.

In step S1114, the revealed unique identifier is transmitted to a central repository of unique identifiers. The central repository can be the manufacturer or distributor of the product or can be a third party. As discussed herein, the unique identifier can be transmitted via a variety of mediums including electronic and manual transmissions. For example, a supply chain actor can use a cell phone to transmit an SMS text message containing the revealed unique identifier to defined destination. Alternatively, the supply chain actor can transmit the revealed unique identifier through a telephone in response to human or automated prompts. In another example, a supply chain actor can utilize a Web form or other networked application to transmit the revealed unique identifier. In still another example, the supply chain actor can use a scanning device to read the revealed unique identifier for immediate or later transfer.

In step S1116, the revealed unique identifier is compared to stored unique identifier. For example, a query containing the revealed unique identifier can be executed against a database containing a plurality of unique identifiers. Information regarding the revealed unique identifier can then be examined (e.g., by a computer). For example, the revealed unique identifier can be deemed unauthentic if the unique identifier was not recorded as assigned to product or was previously validated. Other information can also be provided. For example, if the difference between the current date and the date of manufacture optionally stored with the revealed unique identifier exceeds a defined interval, the product can be deemed to be expired.

In step S1118, information regarding the revealed unique identifier can be recorded. This information can include the revealed unique identifier that was validated, the time of validation, and the like. More advanced information can also be stored to enable more sophisticated analysis of the stored data. For example, the origin of the verification request (e.g., telephone number, location of the telephone, and the like) can be recorded. Recordation of this information allows for identification of anomalous patterns. For example, the revelation and transmission of a first unique identifier from Zaire followed by the revelation and transmission of a second unique identifier in Kazakhstan can be flagged as suspicious. Moreover, tracking of locations can allow manufacturers to learn more about the distribution patterns of their products, particularly in developing countries and in gray markets.

Information regarding the revealed unique identifier can also include time and date information about when the unique identifier was submitted for validation. Such information is valuable to manufacturers, distributors, and the like because it provide an accurate measure of the duration between manufacture and use by the end consumer and/or the duration of various stages of the supply chain. Advantageously, the invention enables to collection of this information in cash-based economies that do not present the data collection and mining opportunities associated with electronic transactions such as those utilizing credit or debit cards.

In step S1120, a message regarding the authenticity of the revealed unique identifier (and thereby, the product) is transmitted back to the individual that originally transmitted the revealed unique identifier. The response message can be transmitted in the same or different manner as the original message.

Incorporation of Unique Identifiers into Products and/or Product Packaging

As discussed throughout the application, unique identifiers can be incorporated directly within individual products, groups of products, and/or product packaging. Various approaches may be favored in certain situations depending on the nature of the product, the nature of the packaging, and the nature of the distribution chain for the product.

For example, the incorporation of unique identifiers within product packaging may be favored for pharmaceuticals because of the limited space for printing unique identifiers on individual pills and the inability to print a unique identifier on liquid and aerosol forms of pharmaceuticals.

In another example, the printing of unique identifiers directly onto a wine label and/or etching or stamping of a unique identifier direction onto a wine bottle may be preferred because wine bottles are often not sold with any additional packaging.

In still another example, the incorporation of unique identifiers directly into artwork (e.g., by the artist and preferably in a discrete location) may be preferred because any packaging for such artwork (e.g., crates for sculptures) is typically not retained by the owner.

### Verification of Tickets and Other Vouchers

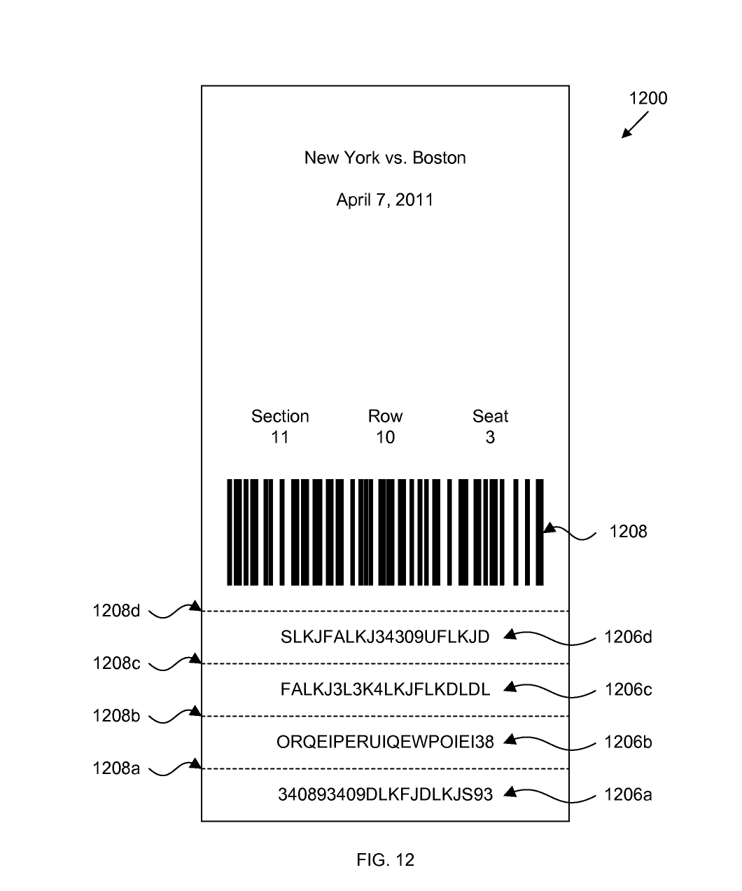

Referring now to FIG. 12, one or more unique identifiers 1206 can be applied to a ticket 1200 (e.g., a ticket to a concert or sporting event) or other voucher. Such a unique identifier 1206 enables verification of the authenticity of the ticket 1200 on the secondary market (e.g., when purchasing from a ticket broker, scalper, and the like).

A plurality of unique identifiers 1206a-1206d can be applied to the ticket 1200 and can selectively revealed using the techniques and materials discussed herein or can be viewable at all times. Unique identifiers 1206 can be selectively removed (e.g., through the use of perforations 1208). In such an embodiment, each unique identifier 1206 can be removed from the ticket after verification. The unique identifiers 1206 can be printed in a specific order and can be optionally labeled with an ordinal number so that users know which unique identifier 1206 to utilize first. For example, unique identifier 1206a can be utilized for verification in a first transaction before being removed from ticker 1200. Unique identifier 1206b can then be utilized for verification in a second transaction, and so on.

Ticket 1200 can include other information for processing the ticket 1200 (e.g., when the bearer of the ticket 1200 seeks to enter the venue for the event). For example, the ticket 1200 can include a barcode 1208.

### Methods of Verifying Authenticity of Tickets and Other Vouchers

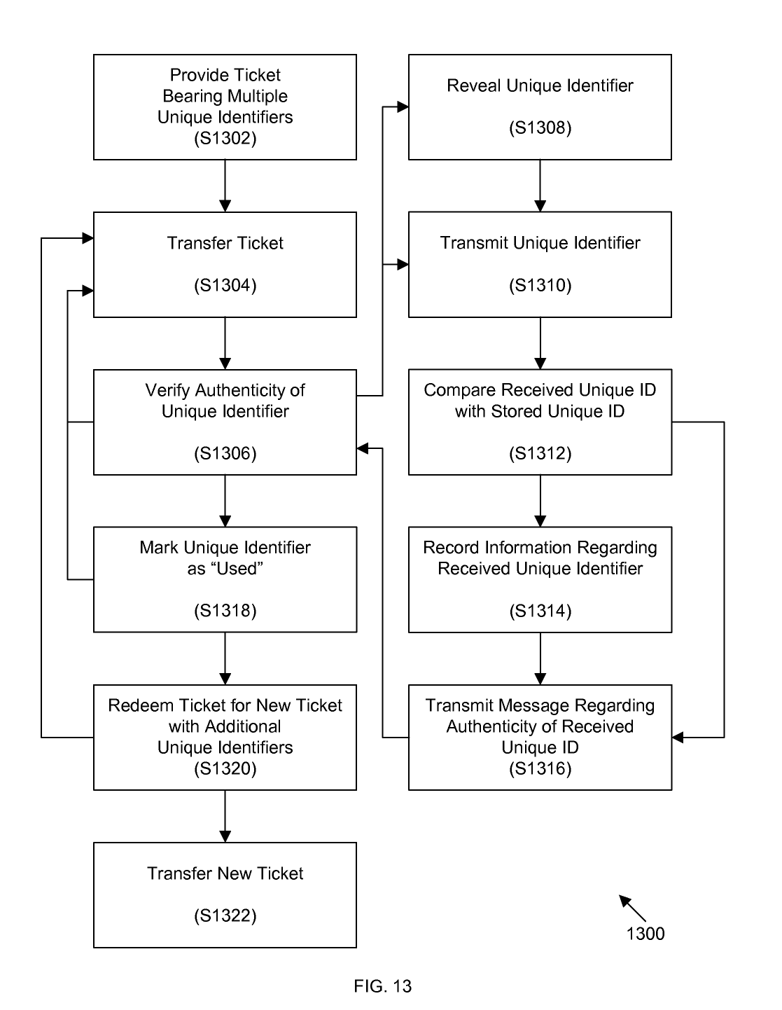

Referring now to FIG. 13, a method 1300 of verifying the authenticity of a ticket or other voucher is provided. As above, the term “ticket” will be used in this description for conciseness.

In step S1302, a ticket bearing multiple unique identifiers is provided. For example, the ticket may be ticket 1200 as described herein.

In step S1304, the ticket is transferred. For example, the ticket can be sold from a ticket issuer (e.g., a concert or sporting venue or a promoter such as Live Nation of Beverly Hills, Calif.) to directly to a consumer or a ticket broker, from a ticket broker to a consumer, from a consumer to a ticket broker, from a consumer to a consumer, and the like.

In step S1306, the authenticity of one of the unique identifiers is verified. In many embodiments, this verification will take place in conjunction with a transfer, but can occur separately from a transaction.

The authenticity of a unique identifier can be verified through one or more steps as described herein. For example, the unique identifier can be revealed (S1308), if hidden.

The unique identifier can be transmitted to a central repository of unique identifiers in step S1310 for verification. The central repository of unique identifiers can be the ticket issuer or can be a third party engaged by the ticket issuer.

In step S1312, the received unique identifier can be compared with a stored unique identifier.

In step S1314, information regarding the received unique identifier can be recorded in the central repository of unique identifiers.

In step S1316, a message regarding the authenticity of the received unique identifier can be transmitted to the individual seeking to verify its authenticity.

In step S1318, the unique identifier can optionally be marked as “used.” This can be accomplished in a variety of ways including physical removal of the portion of the ticket containing the verified unique identifier (e.g., by utilizing perforations 1208 on ticket 1200), by marking the verified unique identifier with ink or other marking means, and/or by designation of the unique identifier as “used” in a database. In some embodiments, a single unique identifier can be validated several times before being marked as “used” in the database, thereby allowing for multiple transfers of the ticket before exhausting all of the unique identifiers.

After several transactions, all of the unique identifiers may have been verified. If further transactions are desired, the ticket can be optionally redeemed in step S1320 for a new ticket. For example, the ticket can be presented to the ticket issuer, who can optionally charge a fee for the new ticket.

In step S1322, the new ticket can be transferred and the steps described above can be repeated for future transactions.

### EQUIVALENTS

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, computers, clients, servers and the like) shown as distinct for purposes of illustration may be incorporated within other functional elements, separated in different hardware, or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

### INCORPORATION BY REFERENCE

The entire contents of all patents, published patent applications, and other references cited herein are hereby expressly incorporated herein in their entireties by reference.

1. A method of verifying the authenticity of a product through a plurality of stages of a supply chain, the method comprising:
providing a product having a plurality of distinct hidden unique identifiers incorporated with the product; and
at each of at least one of the plurality of stages of the supply chain, verifying the authenticity of a revealed unique identifier;
thereby verifying the authenticity of the product.

2. The method of claim 1, wherein the step of verifying the authenticity of the revealed unique identifier comprises:
comparing the revealed unique identifier with another unique identifier stored in a database.

3. The method of claim 2, wherein the step of verifying the authenticity of the revealed unique identifier further comprises:
if the revealed unique identifier is marked in the database as valid, indicating that the revealed unique identifier is authentic.

4. The method of claim 2, wherein the step of verifying the authenticity of the revealed unique identifier further comprises:
if the revealed unique identifier is marked in the database as invalid, indicating that the revealed unique identifier is not authentic.

5. The method of claim 2, wherein the step of verifying the authenticity of the revealed unique identifier further comprises:
if the revealed unique identifier is marked in the database as used, indicating that the revealed unique identifier is not authentic.

6. The method of claim 2, wherein the step of verifying the authenticity of the revealed unique identifier further comprises:
if the revealed unique identifier is marked in the database as stolen, indicating that the revealed unique identifier is not authentic.

7. The method of claim 2, wherein the step of verifying the authenticity of the revealed unique identifier further comprises:
if the revealed unique identifier is marked in the database as compromised, indicating that the revealed unique identifier is not authentic.

8. The method of claim 1, wherein each of the plurality of distinct hidden unique identifiers are incorporated in individual blisters within one or more blister packs.

9. The method of claim 1, wherein one or more of the plurality of distinct hidden unique identifiers are obscured by a removable opaque coating.

10. The method of claim 1, wherein one or more of the plurality of distinct hidden unique identifiers can be revealed by one or more selected from the group consisting of exposure to a temperature change, exposure to a substance, exposure to light, use of a lens of a defined wavelength, and exposure to energy of a defined wavelength.

11. The method of claim 1, wherein the revealed unique identifier is communicated via one or more communication means selected from the group consisting of visual inspection, voice, telephone, gestures, human-machine interactions, key presses, facsimile, e-mail, Internet communications, intranet communications, and Short Message Service (SMS), Unstructured Supplementary Service Data (USSD), Process Supplementary Service Request (PSSR), Unstructured Supplementary Service Request (USSR), Unstructured Supplementary Service Notify (USSN), and SIM Application Toolkit (STK).

12. The method of claim 1, wherein one or more of the hidden unique identifiers are selected from the group consisting of characters, letters, numerals, bar codes, matrix codes, human readable markings, and machine-readable markings.

13. The method of claim 1, wherein each of the distinct hidden unique identifiers is readable at a distinct wavelength.

14. The method of claim 1, wherein the product is received within tamper-evident packaging.

15. The method of claim 1, further comprising:
instructing a supply chain actor to reveal one of the plurality of distinct hidden unique identifiers.

16. The method of claim 15, wherein the supply chain actor is a human.

17. The method of claim 15, wherein the supply chain actor is a machine.

18. The method of claim 1, wherein the verifying step is performed at each of the plurality of stages of the supply chain.

19. The method of claim 1, wherein one or more of the plurality of distinct hidden unique identifiers can be modified by one or more selected from the group consisting of exposure to an environmental condition, exposure to a substance, and use of a lens of a defined wavelength.

20. The method of claim 19, wherein the environmental condition is selected from the group consisting of: a temperature, light, and energy of a defined condition.

21. The method of claim 19, wherein one or more of the plurality of distinct hidden unique identifiers can be modified by exposure to the environmental condition for a defined period of time.

22. The method of claim 19, wherein the substance is water.

23. The method of claim 1, further comprising:
recording a time at which the revealed unique identifier is received; and
calculating a difference between a previously recorded time and the time at which the revealed unique identifier was received.

24. The method of claim 1, wherein the product is a ticket.

25. The method of claim 1, wherein the product is a voucher.

26. The method of claim 1, further comprising:
removing the revealed unique identifier from the product.

27. A product comprising:
a plurality of distinct hidden unique identifiers;
wherein the plurality of distinct unique identifiers can be selectively revealed.

28. A tamper-evident package comprising:
a plurality of distinct hidden unique identifiers;
wherein the plurality of distinct unique identifiers can be selectively revealed.

29. The tamper-evident package of claim 28, wherein the plurality of distinct hidden unique identifiers are incorporated within one or more blister packs.

30. The tamper-evident package of claim 28, wherein each of the plurality of distinct hidden unique identifiers are incorporated in individual blisters within the one or more blister packs.

31. The tamper-evident package of claim 28, wherein the plurality of distinct hidden unique identifiers is incorporated within one or more scratch cards.

32. The tamper-evident package of claim 28, wherein one or more of the hidden unique identifiers are selected from the group consisting of characters, letters, numerals, bar codes, matrix codes, human readable markings, and machine-readable markings.

33. The tamper-evident package of claim 28, wherein each of the distinct hidden unique identifiers is readable at a distinct wavelength.

34. The tamper-evident package of claim 28, wherein one or more of the plurality of distinct hidden unique identifiers can be modified by one or more selected from the group consisting of: exposure to an environmental condition, exposure to a substance, and use of a lens of a defined wavelength.

35. The tamper-evident package of claim 34, wherein the environmental condition is selected from the group consisting of: a temperature, light, energy, stress, strain, and magnetic forces.

36. The tamper-evident package of claim 34, wherein one or more of the plurality of distinct hidden unique identifiers can be modified by exposure to the environmental condition for a defined period of time.

37. The tamper-evident package of claim 34, wherein the substance is water.

38. A ticket comprising:
a plurality of unique identifiers.

39. The ticket of claim 38, wherein the ticket permits admission to an event selected from the group consisting of: an entertainment event, an exhibition, an art exhibition, a tour, a museum, an amusement park, a theme park, a sporting event, a concert, a play, and a movie.

40. The ticket of claim 38, wherein the plurality of unique identifiers are hidden.

41. The ticket of claim 38, wherein each of the plurality of unique identifiers is printed on a separate perforated portion of the ticket.
